(19) United States
(12) Patent Application Publication
(10) Pub. No.: US 2017/0353487 A1
(43) Pub. Date: Dec. 7, 2017

(54) CONTROLLING DATA ACCESS IN A SECURITY INFORMATION SHARING PLATFORM

(71) Applicant: HEWLETT PACKARD ENTERPRISE DEVELOPMENT LP, Houston, TX (US)

(72) Inventors: Terence Spies, Cupertino, CA (US); Tomas Sander, Princeton, CA (US); Susan K. LANGFORD, Sunnyvale, CA (US)

(21) Appl. No.: 15/169,950

(22) Filed: Jun. 1, 2016

(51) Int. Cl. H04L 29/06; H04L 9/08

(52) U.S. Cl. CPC H04L 63/1441; H04L 63/20; H04L 9/0861; H04L 63/0428; H04L 63/06

(57) ABSTRACT

Examples disclosed herein relate to controlling data access on a security information sharing platform. Some examples may enable receiving, from a first member of a first community of the security information sharing platform that enables sharing of security information among a plurality of users, a request to share a first set of information. Some examples may enable determining, based on a set of parameters associated with the request to share the first set of information, an encryption mechanism to use to encrypt the first set of information. Some examples may enable encrypting the first set of information using the determined encryption mechanism. Some examples may enable sharing the encrypted first set of information.

### BACKGROUND

Users of a security information sharing platform share security indicators, security alerts, and/or other security-related information (e.g., mitigations strategies, attackers, attack campaigns and trends, threat intelligence information, etc.) with other users in an effort to advise the other users of any security threats, or to gain information related to security threats from other users.

### BRIEF DESCRIPTION OF THE DRAWINGS

The following detailed description references the drawings, wherein:

FIG. 1 is a block diagram depicting an example environment in which various examples may be implemented as a security information sharing platform that controls data access.

FIG. 2 is a block diagram depicting an example security information sharing platform that controls data access.

FIG. 3 is a block diagram depicting an example machine-readable storage medium comprising instructions executable by a processor for controlling data access on a security information sharing platform.

FIG. 4 is a block diagram depicting an example machine-readable storage medium comprising instructions executable by a processor for controlling data access on a security information sharing platform.

FIG. 5 is a flow diagram depicting an example method for controlling data access on a security information sharing platform.

FIG. 6 is a flow diagram depicting an example method for controlling data access on a security information sharing platform.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Users of a security information sharing platform share security indicators, security alerts, and/or other information (e.g., mitigations strategies, attackers, attack campaigns and trends, threat intelligence information, etc.) with other users in an effort to advise the other users of any security threats, or to gain information related to security threats from other users. The other users with whom the security information is shared typically belong to a community that is selected by the user for sharing, or to the same community as the user. The other users of such communities may further share the security information with further users and/or communities. A “security indicator,” as used herein, may refer to a detection guidance for a security threat and/or vulnerability. In other words, the security indicator may specify what to detect or look for (e.g., an observable) and/or what it means if detected. For example, the security indicator may specify a certain Internet Protocol (IP) address to look for in the network traffic. The security indicator may include the information that the detection of that IP address in the network traffic can indicate a certain malicious security threat such as a Trojan virus.

A “user,” as used herein, may include an individual, organization, or any entity that may send, receive, and/or share the security information. A community may include a plurality of users. For example, a community may include a plurality of individuals in a particular area of interest. A community may include a global community where any user may join, for example, via subscription. A community may also be a vertical-based community. For example, a vertical-based community may be a healthcare or a financial community.

In some instances, a community may also be a private community with a limited number of selected users. A private community may be defined by explicitly enumerating its members by, for example, selecting a particular set of users of the security information sharing platform. However, it is not an easy task to facilitate and manage a private community with a limited number of selected users. It may be technically challenging, for example, to determine how to share security information among members of a private community without sharing that security information with the other users of the security information sharing platform. Further, that technical challenge may be exacerbated in situations where a member sharing information wishes to control access to data shared by that member.

Since communities are dynamic and the information shared may be extremely sensitive, it is desirable to have controls around data access that are cryptographically enforced. As an example, it may be important that messages may only be shared with certain entities or individuals based on applied security policies. For this data access control to be effective, it should be enforced by cryptographic controls rather than through server based access controls, which can be changed or subverted by an administrator. It may be technically challenging, however, to effectively control data access of shared information for dynamic communities through cryptographic controls.

Since different messages and/or originators may have different requirements for security, a technical solution for facilitating data access control via cryptographic protocols may be to have a policy-based engine to take those security requirements and produce a key management/encryption algorithm choice that best fits the requirement. As an example, an entity may produce regular reports that are encrypted into an established group where membership is controlled at a key management server, and identity-based encryption (IBE) may be the best fit for that data. In another example, the entity may at some point produce data that has a wider readership list, where the readers are described by attributes, and in this case uses attribute-based encryption (ABE) to encrypt these data items.

As such, a novel technical solution to these technical challenges may include a policy-based engine that can dynamically determine a key management regime for sharing information and controlling access to shared data. This policy engine may enable dynamic determination of encryption functions for a request to share information on a user-by-user or data-by-data level depending on sensitivity specifications that may comprise properties of the user, properties of the data, a function computed on properties of the data originator, data contents or the set of specified data recipients, and/or based on other factors related to the request to share information.

Examples disclosed herein provide technical solutions to these technical challenges by controlling data access on a security information sharing. In this way, a request to share information from a first set of information may be received via the security information sharing platform, and an encryption mechanism to use to encrypt the first set of information may be determined. Some examples may enable determining the encryption mechanism based on a set of parameters associated with the request. Some examples may enable encrypting the first set of information using the determined encryption mechanism and sharing the encrypted first set of information.

The terminology used herein is for the purpose of describing particular embodiments only and is not intended to be limiting. As used herein, the singular forms “a” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

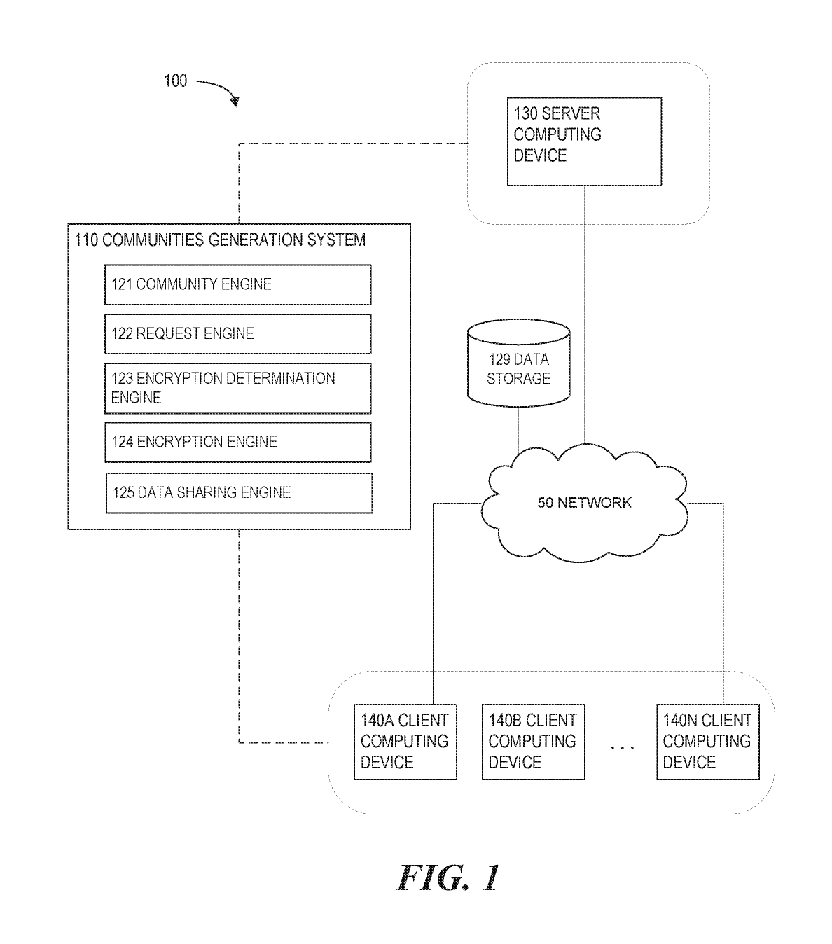

FIG. 1 is an example environment 100 in which various examples may be implemented as a system 110 for controlling data access on a security information sharing platform. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, system 110 and the various components described herein may be implemented in hardware and/or a combination of hardware and programming that configures hardware. Furthermore, in FIG. 1 and other Figures described herein, different numbers of components or entities than depicted may be used.

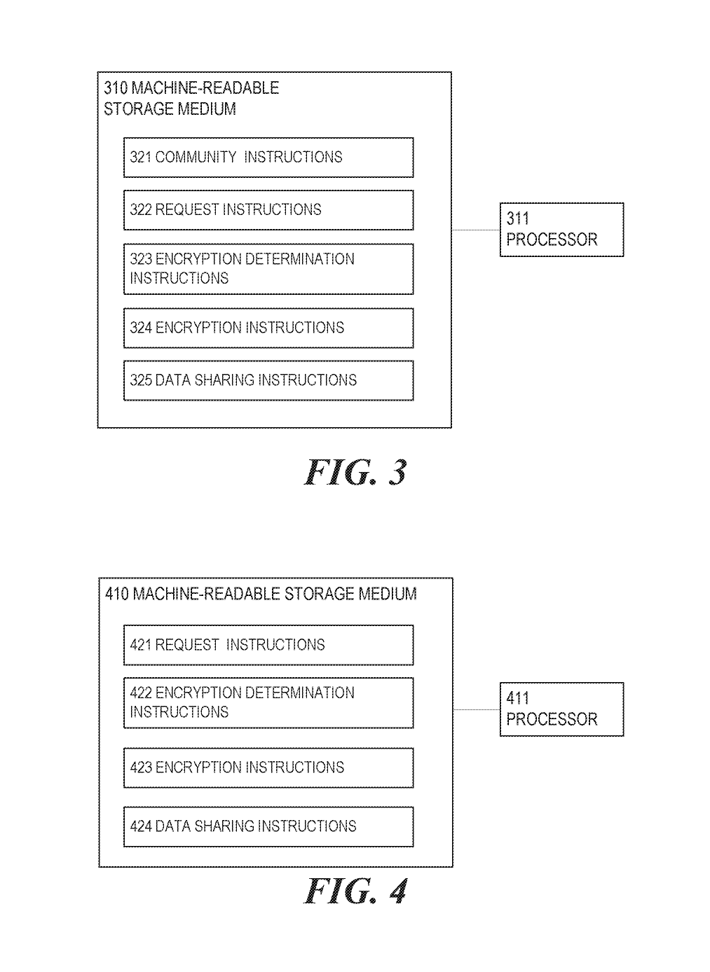

System 110 may comprise a community engine 121, a request engine 122, an encryption determination engine 123, an encryption engine 124, a data sharing engine 125 and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Community engine 121 may manage and/or store, in a database (e.g., data storage 129), various user attributes associated with a user of the security information sharing platform. As used herein, a “user attribute” may refer to a characteristic and/or property of the user with which the user attribute is associated.

Various user attributes associated with a user may comprise an attribute related to: an industry sector of the user (e.g., a financial industry, healthcare industry, etc.), a geographical region of the user (e.g., a geographical region where the user is located in), an organization that the user belong to (e.g., a name, size, threat profile and/or any other information about the organization such as an employer, a standards organization, etc.), user reputations of the user (e.g., a user level or badge status of the user such as “Trusted User,” “Malware Expert Level V,” “Forensics Expert,” “High Performer,” etc.), a citizenship status of the user, an environmental condition (e.g., terrorist threat level of the geographical region of the user, eta), an indication of whether the user represents a threat intelligence feed vendor, a security clearance level of the user, user status of the user in the security information sharing platform (e.g., paid subscription level to the security information sharing platform such as Silver status, Platinum status, Gold status, etc.), etc.

User attributes may be assigned to, therefore be associated with, a user in various ways. In one example, the user may specify a user attribute that describes that user by providing information to the security information sharing platform regarding the user's organization, geographical region, expertise, etc. In another example, a user attribute may be automatically extracted from a user profile of the user. A user profile may be created within the security information sharing platform for internal use. In some instances, a user profile that has been externally created may be imported into the security information sharing platform. User attributes included in the user profile may be extracted, parsed, and/or stored in a database (e.g., data storage 129). In yet another example, another user may be allowed to assign a user attribute to the user. In this example, a third-party user may be delegated an authority to assign a user attribute to the user (e.g., a reseller of a product may designate user attributes to its customers).

In some implementations, user attributes that are associated with a user may be hidden from the user. The security information sharing platform may store (e.g., in a data storage 129) a set of user attributes, a user identification of the user, and/or associations thereof, but it may be configured not to reveal the associations to the user.

In some implementations, a certain collection of user attributes may form a set of community attributes to be used to generate a particular community. “A set of community attributes,” as used herein, may refer to a particular collection and/or assembly of user attributes that describe users to be included in a particular community. For example, a set of community attributes may be in form of a monotonic expression. It may be expressed as: “Top 10 US Bank” AND “Security Clearance.” Any users associated with a first user attribute (e.g., “TOP 10 US Bank”) and a second user attribute (e.g., “Security Clearance”) would satisfy this set of community attributes. Another example set of community attributes may comprise: (“Top 10 US Bank” AND “Security Clearance”) OR “China”. Note that a user that is not associated with the user attribute “China” may still satisfy this set of community attributes as long as the user is associated with “Top 10 US Bank” and “Security Clearance.” In some situations, a set of community attributes may be expressed in such a way that it includes a negation such as: (“Top 10 US Bank” AND “Security Clearance”) NOT “Russia”. In this case, a user that is associated with “Russia” may not satisfy the set of community attributes as defined.

In some implementations, the set of community attributes may be used as a name and/or label for the community being generated based on that set of community attributes. In this way, by simply looking at the name and/or label, the type of the community can be easily identified.

Community engine 121 may generate a community on the security information sharing platform. The generation of the community may be user-initiated or system-initiated. In some implementations, a user (e.g., a case initiator) may create the community by providing a list of users to be included in the community (e.g., explicitly enumerating a particular set of users). A user (e.g. a case initiator) may create a community in an implicit way by defining a set of community attributes characterizing its members/users rather than explicitly enumerating each individual member/user to be included. In this way, if a large number of users with a common set of characteristics were to be added to the community, it may be more effective to create a community based on a set of community attributes.

In some implementations, the security information sharing platform may automatically identify and/or invite users who might be interested in joining the community based on information that has been collected about users of the platform (e.g., the platform may automatically identify and/or invite users who have been under similar security threats in the past). In some instances, a set of community attributes (e.g., “Banks” AND “US”) may be automatically determined based on a certain triggering event (e.g., a serious threat noticed in banks in US). In this case, users associated with a set of user attributes that would satisfy the set of community attributes may join the community (e.g., the community generated based on “Banks” AND “US”).

In some implementations, once the set of community attributes is defined (e.g., whether user-initiated or system-initiated), community engine 121 may notify users associated with user attributes that would satisfy the set of community attributes. Users may be asked to confirm (e.g., accept or reject) the invitation to join the community.

In some implementations, an identification of one user of the community may be kept hidden from another user of the same community. The user may choose to voluntarily reveal the user's identity (e.g., add it to the community member list) or keep it anonymous.

In some examples, community engine 121 may facilitate generation and management of multiple communities on the security information sharing platform, where each community is generated based on the mechanisms described herein.

Request engine 122 may receive a request to share information from a member or the community. For example, request engine 122 may receive a first request to share information from a first member of a first community of the security information sharing platform.

In some examples, the request may comprise a security indicator for the community. A “security indicator,” as used herein, may refer to a detection guidance for a security threat and/or vulnerability. In other words, the security indicator may specify what to detect or look for (e.g., an observable) and/or what it means if detected. For example, the security indicator may specify a certain Internet Protocol (IP) address to look for in the network traffic. The security indicator may include the information that the detection of that IP address in the network traffic can indicate a certain malicious security threat such as a Trojan virus. An “observable,” as used herein, may refer to an event pertinent to the operation of computers and networks (e.g., an event occurring in network, servers, applications, databases, and/or various components of any computer system). Examples of an observable may include but are not limited to: an IP address, a domain name, an e-mail address, Uniform Resource Locator (URL), and a software file hash. A security indicator may comprise a single observable (e.g., “a new file is created by an executable”) or a plurality of observables (e.g., “a new file is created by an executable and “the executable connects to domain X”).

The request to share the first set of information may comprise and/or be associated with a set of parameters. In some instances, the request may comprise a set of parameters. In some instances, along with the or instead of the set of parameters included in the request, the request engine 122 may determine a set of parameters associated with the request. The request engine 122 may store the request and its associated set of parameters in the data storage 129.

The set of parameters may include, for example, user parameters, content parameters, situational parameters, and/or other types of parameters related to the request to share the first set of information.

User parameters may comprise, for example, a property of the first member that requested to share the data, a property of one or more recipients of the request, a shared property of the recipient(s) of the request, a property of the first community (e.g., an attribute of the first community), and/or other properties that relate to a user that could be associated with the first request. A property may comprise an attribute or any other characteristic or information.

Content parameters may comprise, for example, a property about the content of the request, an information type of the request, relevance of the first set of information, an indicator of whether the content comprises an observable, an indicator of whether the content comprises a security indicator, and/or another property that relates to content of the request.

Situational parameters may comprise, for example, an alert level in the security information sharing platform, a sensitivity level associated with the first set of information, a sensitivity level associated with the first community, a reputation of the first member, a reputation of an intended recipient of the first set of information, a combined reputation of intended recipient(s) of the first set of information, and/or other information related to the situation and/or environment in which the request is received.

Encryption determination engine 123 may determine, based on a set of parameters associated with the request to share the first set of information, an encryption mechanism to use to encrypt the first set of information. The encryption mechanism may comprise any encryption mechanism that transforms the first set of information using secret information such that an unintended recipient of the encrypted first set of information would be unable to determine the first set of information from the transformed first set of information.

In some examples, the security information sharing platform may comprise a set of key management capabilities, where each key management capability can be an encryption mechanism used to encrypt the first set of information. In some examples, the set of key management capabilities used may be standard through the security information sharing platform.

In some examples, the first community may comprise a set of key management capabilities that it allows for use to encrypt information communicated via the community. For example, the first community may, via the encryption determination engine 123 and/or other component, customize the set of key management capabilities that it allows for use as an encryption mechanism. The customized set of key management capabilities may comprise all of or a subset of the standard key management capabilities, may comprise a different set of key management capabilities than the standard key management capabilities, and/or may otherwise comprise key management capabilities used as encryption mechanisms.

In some examples, the encryption determination engine 123 may use a policy to determine, based on the set of parameters associated with the request to share the first set of information, the encryption mechanism to use to encrypt the first set of information. A policy may comprise, for example, a set of parameters, a function of a set of parameters, another configuration of a set of parameters, any combination thereof, and a corresponding encryption mechanism. As such, the encryption determination engine 123 may compare the set of parameters associated with the request with a set of policies to determine the encryption mechanism to use.

In some examples, a set of policies may be stored in data storage 129. In some examples, the set of policies may be a set of policies that are standard for the security information sharing platform. In some examples, the individual policy to be used may be received from the first member along with the request and may be stored in data storage 129. In some examples, the set of policies may be standard for the first community. In some examples, the set of policies may be customized. For example, the policy may be customized by the first member that provides the request. In other examples, the set of policies may be customized by the community or based on preferences of the community.

The encryption determination engine 123 may determine a policy that best matches the set of parameters associated with the request and may determine the encryption mechanism based on the encryption mechanism associated with the determined matching policy. In some examples, policies may be ranked in order of importance and/or preference. In these examples, the encryption determination engine 123 may check each policy in order of rank to find the first policy that matches. In some examples, policies may be indicated as preferred. In these examples, encryption determination engine 123 may check the preferred policies first to determine whether a preferred policy matches. Responsive to determining that no policy matches, the encryption determination engine 123 may use a standard encryption mechanism and/or a standard policy associated with a standard encryption mechanism.

In this manner, the encryption determination engine 123 may determine a separate encryption mechanism for each request received by the request engine 122. For example, for a second request from the first member, the encryption determination engine 123 may determine a same or different encryption mechanism be used to encrypt the second request as the first request, based on policy associated with second request. In another example, for a third request from a member of a second community, the encryption determination engine 123 may determine a same or different encryption mechanism be used to encrypt third request, based on policy associated with third request.

Encryption engine 124 may encrypt the first set of information using the determined encryption mechanism. Encryption engine 124 may store the encrypted first set of information in the data storage 129 and make it available for sharing.

Data sharing engine 125 may share the encrypted first set of information. Data sharing engine 125 may share the encrypted first set of information with the intended recipient(s) of the received request from the first member of the first community.

In performing their respective functions, engines 121-125 may access data storage 129 and/or other suitable database(s). Data storage 129 may represent any memory accessible to system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. System 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

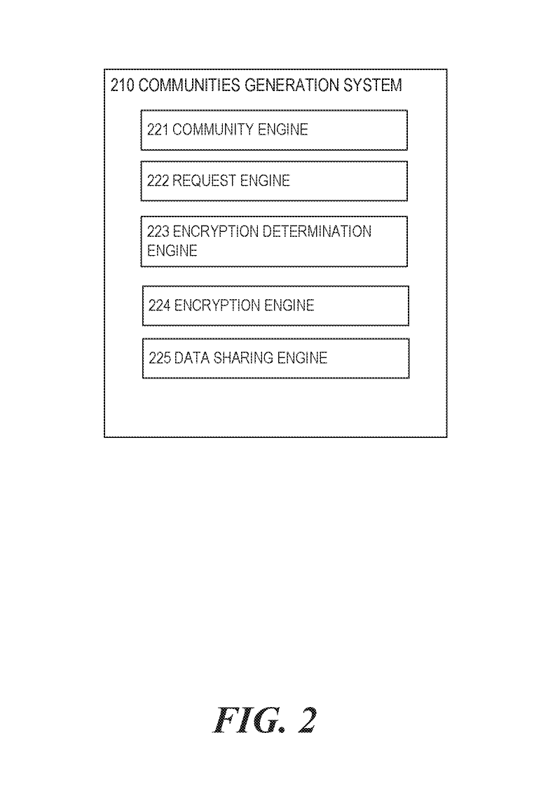

FIG. 2 is a block diagram depicting an example system 210 for controlling data access on a security information sharing platform. System 210 may comprise a community engine 221, a request engine 222, an encryption determination engine 223, an encryption engine 224, a data sharing engine 225, and/or other engines. Engines 221, 222, 223, 224, and 225 represent engines 121, 122, 123, 124, and 125, respectively.

FIG. 3 is a block diagram depicting an example machine-readable storage medium 310 comprising instructions executable by a processor for controlling data access on a security information sharing platform.

In the foregoing discussion, engines 121-125 were described as combinations of hardware and programming. Engines 121-125 may be implemented in a number of fashions. Referring to FIG. 3, the programming may be processor executable instructions 321-325 stored on a machine-readable storage medium 310 and the hardware may include a processor 311 for executing those instructions. Thus, machine-readable storage medium 310 can be said to store program instructions or code that when executed by processor 311 implements 110 of FIG. 1.

In FIG. 3, the executable program instructions in machine-readable storage medium 310 are depicted as community instructions 321, request instructions 322, encryption determination instructions 323, encryption instructions 124, and data sharing instructions 325. Instructions 321-324 represent program instructions that, when executed, cause processor 311 to implement engines 121-125, respectively.

FIG. 4 is a block diagram depicting an example machine-readable storage medium 410 comprising instructions executable by a processor for controlling data access on a security information sharing platform.

Referring to FIG. 4, the programming may be processor executable instructions 421, 422, 423, and 424 stored on a machine-readable storage medium 410 and the hardware may include a processor 411 for executing those instructions. Thus, machine-readable storage medium 410 can be said to store program instructions or code that when executed by processor 411 implements system 110 of FIG. 1.

In FIG. 4, the executable program instructions in machine-readable storage medium 410 are depicted as request instructions 421, encryption determination instructions 422, encryption instructions 423, and data sharing instructions 424. Instructions 421, 422, 423, and 424 represent program instructions that, when executed, cause processor 411 to implement engines 121, 122, 123, 124, and 125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-325, and/or other instructions. As an alternative or in addition to retrieving and executing instructions, processor 311 may include at least one electronic circuit comprising a number of electronic components for performing the functionality of at least one of instructions 321-325, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421, 422, 423, and/or 424, and/or other instructions. As an alternative or in addition to retrieving and executing instructions, processor 411 may include at least one electronic circuit comprising a number of electronic components for performing the functionality of at least one of instructions 421, 422, 423, and/or 424, and/or other instructions.

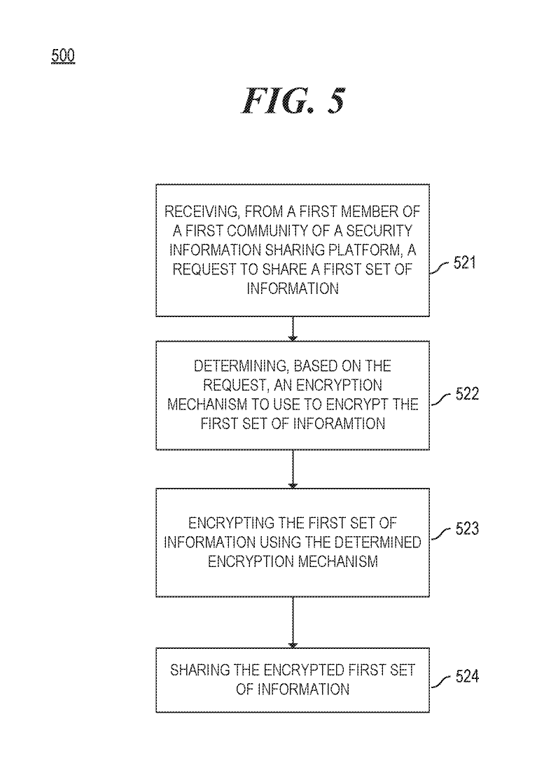

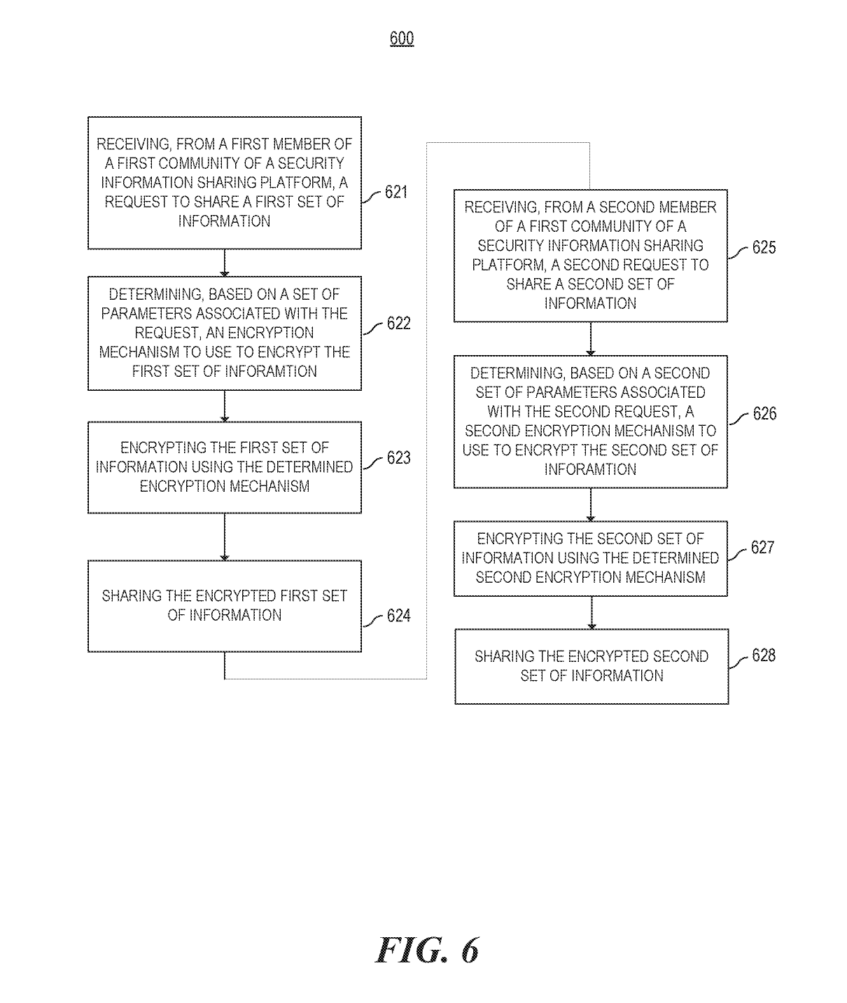

FIG. 5 is a flow diagram depicting an example method 500 for controlling data access on a security information sharing platform. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

In block 521, method 500 may include receiving, from a first member of a first community on a security information sharing platform that enables sharing of security information among a plurality of communities, a request to share a first set of information. Referring back to FIG. 1, in some examples, community engine 121 and request engine 122 may be responsible for implementing block 521. Referring back to FIG. 1, in other examples, request engine 122 may be responsible for implementing block 521.

In block 522, method 500 may include determining, based on the request, an encryption mechanism to user to encrypt the first set of information. Referring back to FIG. 1, encryption determination engine 123 may be responsible for implementing block 522.

In block 523, method 500 may include encrypting the first set of information using the determined encryption mechanism. Referring back to FIG. 1, encryption engine 124 may be responsible for implementing block 523.

In block 524, method 500 may include sharing the encrypted first set of information. Referring back to FIG. 1, data sharing engine 125 may be responsible for implementing block 524.

FIG. 6 is a flow diagram depicting an example method 600 for controlling data access on a security information sharing platform. Method 600 as illustrated (and described in greater detail below) is meant to be an example and, as such, should not be viewed as limiting. Method 600 may be implemented in the form of executable instructions stored on a machine-readable storage medium, such as storage medium 210, and/or in the form of electronic circuitry.

In block 621, method 600 may include receiving, from a first member of a first community on a security information sharing platform that enables sharing of security information among a plurality of communities, a request to share a first set of information. Referring back to FIG. 1, in some examples, community engine 121 and request engine 122 may be responsible for implementing block 621. Referring back to FIG. 1, in other examples, request engine 122 may be responsible for implementing block 621.

In block 622, method 600 may include determining, based on the request, an encryption mechanism to use to encrypt the first set of information. Referring back to FIG. 1, encryption determination engine 123 may be responsible for implementing block 622.

In block 623, method 600 may include encrypting the first set of information using the determined encryption mechanism. Referring back to FIG. 1, encryption engine 124 may be responsible for implementing block 623.

In block 624, method 600 may include sharing the encrypted first set of information. Referring back to FIG. 1, data sharing engine 125 may be responsible for implementing block 624.

In block 625, method 600 may include receiving, from a second member of the first community on the security information sharing platform, a second request to share a second set of information. Referring back to FIG. 1, in some examples, community engine 121 and request engine 122 may be responsible for implementing block 625. Referring back to FIG. 1, in other examples, request engine 122 may be responsible for implementing block 625.

In block 626, method 600 may include determining, based on the second request, a second encryption mechanism to use to encrypt the second set of information. Referring back to FIG. 1, encryption determination engine 123 may be responsible for implementing block 626.

In block 627, method 600 may include encrypting the second set of information using the determined second encryption mechanism. Referring back to FIG. 1, encryption engine 124 may be responsible for implementing block 627.

In block 628, method 600 may include sharing the encrypted second set of information. Referring back to FIG. 1, data sharing engine 125 may be responsible for implementing block 628.

The foregoing disclosure describes a number of example implementations for controlling data access on a security information sharing platform. The disclosed examples may include systems, devices, computer-readable storage media, and methods for controlling data access on a security information sharing platform. For purposes of explanation, certain examples are described with reference to the components illustrated in FIGS. 1-6. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for controlling data access on a security information sharing platform, the method comprising:
receiving, from a first member of a first community of the security information sharing platform that enables sharing of security information among a plurality of users, a request to share a first set of information;
determining, based on a set of parameters associated with the request to share the first set of information, an encryption mechanism to use to encrypt the first set of information;
encrypting the first set of information using the determined encryption mechanism; and
sharing the encrypted first set of information.

2. The method of claim 1, wherein the first set of information comprises a set of recipients, and determining the encryption mechanism comprises:
determining the encryption mechanism based on a shared property of the set of recipients.

3. The method of claim 1, further comprising:
determining the set of parameters based on the request, wherein the set of parameters comprises at least one of: a property of the first member, a property of an intended recipient of the first set of information, or a property shared by each recipient in a set of recipients of the first set of information.

4. The method of claim 1, further comprising:
determining the set of parameters based on the request, wherein the set of parameters comprises at least one of: content of the first set of information, an information type associated with the first set of information, or relevance of the first set of information.

5. The method of claim 1, further comprising:
determining the set of parameters based on the request, wherein the set of parameters comprises a set of situational factors, and wherein the set of situational factors comprise at least one of: an alert level in the threat sharing platform, a sensitivity level associated with the first set of information, a sensitivity level of the private community, or a reputation of the first member.

6. The method of claim 1, wherein the threat sharing platform comprises a set of key management capabilities, and wherein the determined encryption mechanism comprises a first key management capability of the set of key management capabilities.

7. The method of claim 6, further comprising:
receiving information from the first community associating a first key management capability of the set of key management capabilities with a respective set of parameters.

8. The method of claim 6, wherein determining the encryption mechanism comprises:
determining the encryption mechanism based on associations between each key management capability and a respective set of parameters associated with each key management capability.

9. A system for controlling data access on a security information sharing platform, the system comprising:
a physical processor that implements machine readable instructions that cause the system to:
receive, from a first member of a first community of the security information sharing platform that enables sharing of security information among a plurality of users, a request to share a first set of information;
determine, based on a set of parameters associated with the request to share the first set of information, an encryption mechanism to use to encrypt the first set of information;
encrypt the first set of information using the determined encryption mechanism;
share the encrypted first set of information;
receive, from a second member of the first community of the security information sharing platform, a second request to share a second set of information;
determine, based on a second set of parameters associated with the second request, a second encryption mechanism to use to encrypt the second set of information;
encrypt the second set of information using the determined second encryption mechanism; and
share the encrypted second set of information.

10. The system of claim 9, wherein the first set of information comprises a set of recipients, and wherein the physical processor causes the system to:
determine the encryption mechanism based on a shared property of the set of recipients.

11. The system of claim 9, wherein the threat sharing platform comprises a set of request types and a set of policies that comprise information to associate a respective subset of parameters of the set of parameters to a corresponding request type, and
wherein the physical processor causes the system to:
determine a request type of the request from the set of request types;
determine the set of parameters based on a subset of parameters associated with the determined request type of the request.

12. The system of claim 9, wherein the physical processor causes the system to:
determine the set of parameters based on the request, wherein the set of parameters comprises a set of situational factors, and wherein the set of situational factors comprise at least one of: an alert level in the threat sharing platform, a sensitivity level associated with the first set of information, a sensitivity level of the private community, or a reputation of the first member.

13. The system of claim 9, wherein the threat sharing platform comprises a set of key management capabilities,
wherein the physical processor causes the system to:
determine the encryption mechanism based on associations between each key management capability and a respective set of parameters associated with each key management capability.

14. The system of claim 13, wherein the physical processor causes the system to:
receive information from the first community associating a first key management capability of the set of key management capabilities with a respective set of parameters.

15. A computing device for controlling data access on a security information sharing platform, comprising a physical processor and a non-transitory machine-readable storage medium encoded with instructions executable by the physical processor, the non-transitory storage medium comprising instructions to:
receive, from a first member of a first community of the security information sharing platform that enables sharing of security information among a plurality of users, a request to share a first set of information;
determine, based on the request to share the first set of information, an encryption mechanism to use to encrypt the first set of information;
encrypt the first set of information using the determined encryption mechanism; and
share the encrypted first set of information.

16. The computing device of claim 15, wherein the non-transitory storage medium further comprises instructions to:
determine the set of parameters based on the request, wherein the set of parameters comprises at least one of: a set of property factors, a set of information factors, or a set of situational factors.

17. The system of claim 9, wherein the threat sharing platform comprises a set of request types and a set of policies that comprise information to associate a respective subset of parameters of the set of parameters to a corresponding request type, and
wherein the non-transitory storage medium further comprises instructions to:
determine a request type of the request from the set of request types;
determine the set of parameters based on a subset of parameters associated with the determined request type of the request.

18. The computing device of claim 15, wherein the non-transitory storage medium further comprises instructions to:
determine the set of parameters based on the request, wherein the set of parameters comprises a set of situational factors, and wherein the set of situational factors comprise at least one of: an alert level in the threat sharing platform, a sensitivity level associated with the first set of information, a sensitivity level of the private community, or a reputation of the first member.

19. The system of claim 9, wherein the threat sharing platform comprises a set of key management capabilities, and
wherein the non-transitory storage medium further comprises instructions to:
determine the encryption mechanism based on associations between each key management capability and a respective set of parameters associated with each key management capability.

20. The computing device of claim 19, wherein the non-transitory storage medium further comprises instructions to:
receive information from the first community associating a first key management capability of the set of key management capabilities with a respective set of parameters.
